(19) United States
(12) Patent Application Publication
(10) Pub. No.: US 2009/0211371 A1
(43) Pub. Date: Aug. 27, 2009

(54) FLOW MEASURING DEVICE

(75) Inventors: Charles A. Lewis, Carrabelle, FL (US); Robert M. Landis, Mountainside, NJ (US); Sergei Shirokov, Fairlawn, NJ (US); Sarjeet Patel, West Lafayatte, IN (US); Rahul Dandu, Woodbridge, NJ (US); Dharmen Patel, Edison, NJ (US)

Correspondence Address: CAREY, RODRIGUEZ, GREENBERG & PAUL LLP;ATTN: STEVEN M. GREENBERG, ESQ., 950 PENINSULA CORPORATE CIRCLE, SUITE 3020, BOCA RATON, FL, 33487, US

(73) Assignee: MERGENET MEDICAL, INC., Coconut Creek, FL (US)

(21) Appl. No.: 12/298,339

(22) PCT Filed: Apr. 26, 2007
(86) PCT No.: PCT/US07/10186

§ 371 Date: Mar. 10, 2009

Related U.S. Application Data
(60) Provisional application No. 60/794,977, filed on Apr. 26, 2006.

(51) Int. Cl. G01F 1/44

(52) U.S. Cl. 73/861.63

(57) ABSTRACT

A pneumotach for measuring respiratory gas flow is provided and includes a housing defining a lumen and having a longitudinal axis; and an airfoil diametrically supported within the lumen of the housing and extending at least partially thereacross, the airfoil defining a chord axis. The chord axis may be angled with respect to the longitudinal axis.

### CROSS-REFERENCE TO RELATED APPLICATION

This application is the U.S. National Phase under 35 U.S.C. § 371 of International Application No. PCT/US2007/010186, filed on Apr. 26, 2007, which in turn claims the benefit of U.S. Patent Application Ser. No. 60/794,977, filed on Apr. 26, 2006, the disclosures of which Applications are incorporated by reference herein in their entirety.

### BACKGROUND OF THE INVENTION

1. Statement of the Technical Field

The present disclosure relates generally to instruments for measuring flow and more particularly to the field of respiratory medicine and to devices for use in the measuring of inhalation and exhalation of respiratory flow of a patient and the like.

2. Description of the Related Art

A pneumotach flow-head is used as part of a medical respiratory testing device used in pulmonary function testing, or PFT. A pneumotach is used with a spirometer to measure volumetric flow rate, and determine a person's respiratory ability. Spirometer tests require a person to inhale as deeply as possible and then exhale as hard, as fast, and as long as possible in one long breath. These devices are commonly used in doctor's offices and hospitals, providing a market for affordable testing equipment. Pneumotachs are also used in pulmonary function tests, and pulmonary exercise stress testing.

One or the more commonly used designs measure a differential pressure across a fine screen or mesh located in a pipe typically of a standard 22 mm diameter. Pressure taps located on each side of the screen measure the pressure differential. Knowing this pressure differential a volumetric flow rate can be calculated. One of the problems encountered with the current designs is that the moisture in a person's breath may accumulate on the screen during testing and affect the accuracy of the measurement. This moisture build-up, on the screen, in turn further restricts the flow of air causing the calibration to become inaccurate. This problem is greater with exercise testing where the subject's breathing may be measured for 10 minutes or longer.

One of the main design criteria for a pneumotach is that it must measure the flow in both directions so that a volume flow loop can be determined. A flow loop is the flow rate of a person's inhalation and exhalation as a function of volume of air in the lungs. Shown in FIG. 1 is an idealized inspiratory and expiratory flow loop. The graph starts at 0 when a person forcibly exhales all of the breath they can take, after having taken in the largest breath that they are able. This expiratory flow is greatest in the first second, and the peak is the peak expiratory flow rate (PEF). The air which remains that cannot be exhaled is the residual volume (RV) of the lungs. Inspiration takes place and forms a parabolic shape until the total lung capacity (TLC) is reached as shown below the zero axis in FIG. 1, completing the loop. Additionally, pneumotachs are used to measure tidal volume (the volume of the breath at rest), and the volume of the breath during exercise.

The pneumotach must be accurate within a flow range from just above or about 0 to about ±15 L/sec. This volumetric flow rate may be calculated using a pressure difference between two pressure taps in the flow, or between one tap and atmospheric pressure. The device ideally should be as short as possible; this will allow the patient to be comfortable while using the spirometer. Length also adds more resistance to the flow and adds to the dead air space, which causes the subject to re-breath exhaled carbon dioxide. This parameter poses problems to the design of the pneumotach because in order for the flow to be accurately measured it must be fully developed within the tube, a fully developed flow helps dissipate swirls, as well as create a symmetric velocity distribution. In the typical 22 mm tube the flow is turbulent before it reaches the pressure taps. The pneumotach should be designed in a way that it can be produced at a low cost since this piece of equipment typically is placed in the patient's mouth and are designed to be disposable.

A final and important parameter for the design of a pneumotach used especially for exercise testing is the problem of moisture accumulation in the pneumotach 30 head. As the person exhales during the test, moisture from the breath will accumulate in the device. With most current designs, this moisture will collect in the screen that creates the pressure difference and interfere with the accuracy of the pressure measurements. One device uses a heated screen to dissipate the moisture, but this then adds the need for wires and could cause danger or electrical shock to bums to the patent, or cause leakage of radiofrequency radiation. The present invention is designed to avoid some of the limitations or more frequently used pneumotachs.

Flow tubes are also used to measure flow of fluid in equipment. In industrial or medical and other equipment, the flow of air or fluid in a system may be important to the process being done. For example, a flow tube may be used in anesthesia equipment to monitor the amount of gases being delivered to a patient. In another example air flow may be important to efficient combustion in a furnace, and flow measurement might be required to control that flow. Anemometers are another example of a use of a flow tube. For simplicity flow tubes will be referred to as pneumotachs in this document whether intended for measurement of the breath or for other utilities.

### SUMMARY

The present disclosure relates to devices for use in the measuring of fluid flow. Several particular embodiments are particularly adapted for use in measurement of the inhalation and exhalation of respiratory flow of a patient and the like. Others applications, particularly those designed for unidirectional flow have application for flow measurement in a variety of uses.

According to an aspect of the present disclosure, a pneumotach for measuring respiratory gas flow is provided and includes a conduit for enclosing a stream of flow to be measured defining a lumen having a longitudinal axis; and an airfoil diametrically supported within the lumen of the conduit and extending at least partially thereacross, the airfoil defining a chord axis. The chord axis may be angled with respect to the longitudinal axis.

The airfoil may be symmetrical about the chord axis. The airfoil may be symmetrical about a plane that is orthogonal to the chord axis. An upper and a lower surface of the airfoil may have a substantially convex profile. A leading edge and a trailing edge of the airfoil may have an arcuate profile extending from opposed ends thereof.

The pressure distribution on the surface of an airfoil is a consequence of the change in momentum of the fluid as it flows about the airfoil. The pressure depends on the speed of the free-stream flow, as well as the airfoil geometry and the fluid properties. In general, it is possible to relate the pressure at various points along the surface of the airfoil, or on the wall adjacent to the airfoil, to the free-stream velocity. This may be done through experimental calibration, numerical simulations, or exact analytical solutions.

A pressure sensor on or adjacent to the airfoil or in communication with the pressure on or adjacent to the airfoil allows sensing of the pressure and thus determination of the speed of flow of the stream. At least one pressure sensor within or in communication with the fluid stream is required. Pressure may be recorded with at least one port positioned on the surface of the airfoil, or adjacent to it.

For use with a differential pressure sensor, the differential may be recorded between the pressure within the stream and atmospheric pressure, or the pressure may be recorded across two different areas within the stream, ideally where the pressures are at the greatest differential. For practical reasons, such as cost or ease of construction or use, ports may be placed as points where the differential is not at its extremes.

In certain particular embodiments the chord axis of the airfoil may be oriented at an angle of between about 8° and about 10° relative to the longitudinal axis, and preferably, about 9° relative to the longitudinal axis.

The lumen of the conduit in which the fluid stream flows may have a uniform inner diameter along its length. The conduit may be tubular in nature. The conduit may include an inner wall having a Venturi profile. This conduit may form a housing for a pneumotach.

The airfoil may include at least one pressure port formed therein and extending through the tubular housing and through a side surface thereof. Each aperture may be in fluid communication with the at least one pressure port.

In an embodiment, the airfoil defines a leading and a trailing edge. In one embodiment, the airfoil may include at least one aperture formed therein at the leading edge and may include at least one aperture formed therein at the training edge.

The pneumotach may further include at least one pressure port extending into the airfoil through a side surface thereof. A first pressure port may be in fluid communication with the apertures formed at the leading edge of the airfoil. At least one other pressure port may be in fluid communication with the apertures formed at the training edge of the airfoil.

The pneumotach may include at least one pressure port extending into the lumen of the housing and formed proximate a superior leading edge of the airfoil; at least one pressure port extending into the lumen of the housing and formed proximate a superior trailing edge of the pressure port; and at least one sample port extending into the lumen of the housing and formed at any location along the housing.

According to another aspect of the present disclosure, a method of monitoring and/or measuring a fluid flow pressure is provided. The method includes the steps of providing a fluid pressure measuring system including a pneumotach. The pneumotach includes a housing defining a lumen and having a longitudinal axis; and an 15 airfoil diametrically supported within the lumen of the housing and extending at least partially thereacross, wherein the airfoil defining a chord axis, and wherein the chord axis may be angled with respect to the longitudinal axis. The method further includes the steps of flowing a fluid through the housing of the pneumotach, in at least one of a forward and a reverse direction; and measuring a pressure differential on a surface of the airfoil.

The method may further includes the steps of flowing a fluid through the housing of the pneumotach, in a reverse direction; and measuring a pressure differential on a surface of the airfoil so that the pressure may be measured in both directions.

The method may further include incorporating the fluid pressure 25 measuring system as part of a respiratory measurement system.

According to a further aspect of the present disclosure, a system for measuring a fluid flow is provided. The system includes a pneumotach having a housing defining a lumen and having a longitudinal axis; and an airfoil diametrically supported within the lumen of the housing and extending at least partially thereacross, wherein the 30 airfoil defining a chord axis, and wherein the chord axis is angled with respect to the longitudinal axis. The respiratory system further includes a pressure transducer in fluid communication with the lumen of the housing, for measuring a pressure differential in the housing of the pneumotach.

The airfoil may be symmetrical about at least one of the chord axis and a plane that is orthogonal to the chord axis. The chord axis of the airfoil may be oriented at 5 an angle of about 9° relative to the longitudinal axis.

The airfoil of the pneumotach may define a leading edge and a trailing edge. The airfoil may include at least one aperture formed therein at the leading edge and at least one aperture formed therein at the trailing edge. The airfoil of the pneumotach may include at least one aperture formed at the leading edge and at least one aperture formed at the trailing edge.

The pneumotach may further include at least one pressure port extending to the surface of the cord of the airfoil or adjacent to it through a side surface of the housing, wherein a pressure port may be in fluid communication with the stream. The pressure transducer may be fluidly associated with each pressure port.

The pneumotach may have at least one pressure sensor at or adjacent to the airfoil within the housing. The pneumotach may have at least one pressure port in fluid communication with the stream within the housing where the at least one pressure port is on or adjacent to the airfoil surface. The pressure ports may communicate through housing to the stream adjacent to the airfoil, or ports may be placed in the airfoil surface, or a combination of these.

According to yet another aspect of the present disclosure, a system for measuring a fluid flow is provided. The system includes a pneumotach having a housing defining a lumen and having a longitudinal axis; and a uni-directional airfoil diametrically supported within the lumen of the housing and extending at least partially thereacross. The airfoil defines a chord axis. The chord axis is one of angled with respect to the longitudinal axis and aligned with respect to the longitudinal axis. The system further includes a pressure transducer, in fluid communication with the lumen of the housing, for measuring a pressure differential in the housing of the pneumotach for bi-directional fluid flow across the airfoil.

### BRIEF DESCRIPTION OF THE DRAWINGS

By way of example only, preferred embodiments of the disclosure will be described with reference to the accompanying drawings, in which:

FIG. 1 is a graphical illustration of a volumetric flow loop;

FIG. 2 is a schematic illustration of a respiratory system in fluid communication with an airway passage of an individual and which includes a pneumotach of the present disclosure operatively coupled thereto;

FIG. 3 is a perspective view of a pneumotach according to an embodiment of the present disclosure;

FIG. 4 is a distal or proximal end view of the pneumotach of FIG. 3;

FIG. 5 is a cross-sectional view of the pneumotach of FIGS. 3 and 4, as taken through 5-5 of FIG. 4;

FIG. 6 is a cross-sectional, schematic illustration of the pneumotach of FIGS. 3-5; 15

FIG. 7 is a perspective view of a pneumotach according to another aspect of the present disclosure;

FIG. 8 is a distal or proximal end view of the pneumotach of FIG. 7;

FIG. 9 is a cross-sectional, side elevational view of the pneumotach of FIGS. 7 and 8, as taken through 9-9 of FIG. 8;

FIG. 10 is a cross-sectional, perspective view of the pneumotach of FIGS. 7 and 8, as taken through 9-9 of FIG. 8;

FIG. 11 is a side, elevational view of a pneumotach according to another embodiment of the present disclosure;

FIG. 12 is a top, elevational view of the pneumotach of FIG. 11;

FIG. 13 is an enlarged view of the indicated area of detail of FIG. 12;

FIG. 14 is a front, elevational view of the pneumotach of FIGS. 11-13;

FIG. 15 is a side, elevational view of a pneumotach according to yet another embodiment of the present disclosure;

FIG. 16 is a top, elevational view of the pneumotach of FIG. 15;

FIG. 17 is a front, elevational view of the pneumotach of FIGS. 15 and 16;

FIGS. 18A-18D are schematic illustrations of various exemplary airfoils which may be used in the pneumotachs of the present disclosure;

FIG. 19 is a graphical illustration of pressure versus chord location for a symmetrical airfoil as shown in FIG. 18A;

FIG. 20 is a graphical illustration of pressure versus chord location for a symmetrical airfoil as shown in FIG. 18C;

FIG. 21 is a schematic, perspective view of a pneumotach according to a further embodiment of the present disclosure, illustrating an arrangement of pressure ports;

FIG. 22 is a schematic, perspective view of the pneumotach of FIG. 21, illustrating another arrangement of pressure ports;

FIG. 23 is a top, elevational view of a pneumotach according to yet another embodiment of the present disclosure; and

FIG. 24 is a graphical illustration of pressure difference versus flow rates for an asymmetrical airfoil as shown in FIG. 23.

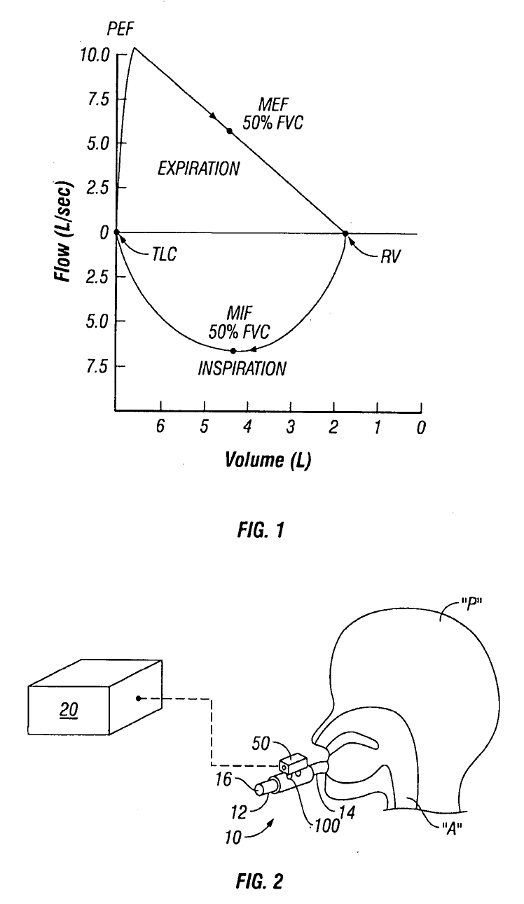

### DETAILED DESCRIPTION OF EMBODIMENTS

Reference is now made specifically to the drawings in which identical or similar elements are designated by the same reference numerals throughout. In the drawings and in the description which follows, the term “proximal”, as is traditional will refer to the end of the device or apparatus which is closest to the individual or patient, while the term “distal” will refer to the end of the device or apparatus which is furthest from the individual or patient.

With reference to FIG. 2, a respiratory system 10 incorporating a pneumotach 100, according to various embodiments of the present disclosure, is depicted. Respiratory system 10 may comprise a breathing circuit which includes an endotracheal tube, a nasal cannula, or any other conduit that is configured to communicate with the 5 airway “A” of an individual or patient “P”. As depicted, one end 14 of respiratory conduit 12 of system is placed in communication with airway “A”, while the other end 16 of respiratory conduit 12 opens to the atmosphere, a source of gas to be inhaled by patient “P”, or a ventilator, as known in the art. Positioned along its length, respiratory conduit 12 includes at least one airway adapter, in the form of a pneumotach 100, which is a component of a type of pressure sensor.

Also shown in FIG. 2, a portable pressure transducer 50 may be coupled with and in flow communication with pneumotach 100. Portable pressure transducer 50 may, in turn, communicate electronically with a computer, such as a pressure or flow monitor 20, as known in the art.

Turning now to FIGS. 3-6, a pneumotach, according to an embodiment of the present disclosure, is generally designated as 100. As seen in FIGS. 3-6, pneumotach 100 includes a tubular housing 110 defining a lumen 112 therethrough having a longitudinal axis “X”. Tubular housing 110 has a uniform or substantially uniform internal and/or external diameter along at least a portion or along an entire length thereof. Tubular housing 110 defines a first end 110a and a second end 110b.

As seen in FIGS. 3-6, pneumotach 100 further includes a vane, fin, airfoil or other aerodynamic member 120 supported in and extending diametrically across lumen 112 of tubular housing 110. Airfoil 120 includes a leading edge 120a and trailing edge 120b defining a chord axis “W” therebetween. Airfoil 120 may be symmetrical along 25 chord axis “W” and/or along a plane extending orthogonal to the chord axis “W”. Leading and trailing edges 120a, 120b may be radiused or rounded as needed or desired. In this manner, air flow over and around airfoil 120 in both a forward direction (arrows “A” of FIG. 6) and reverse direction (arrows “B” of FIG. 6) is substantially uniform or identical. Leading and trailing edges 120a, 120b may be substantially linear along their entire length.

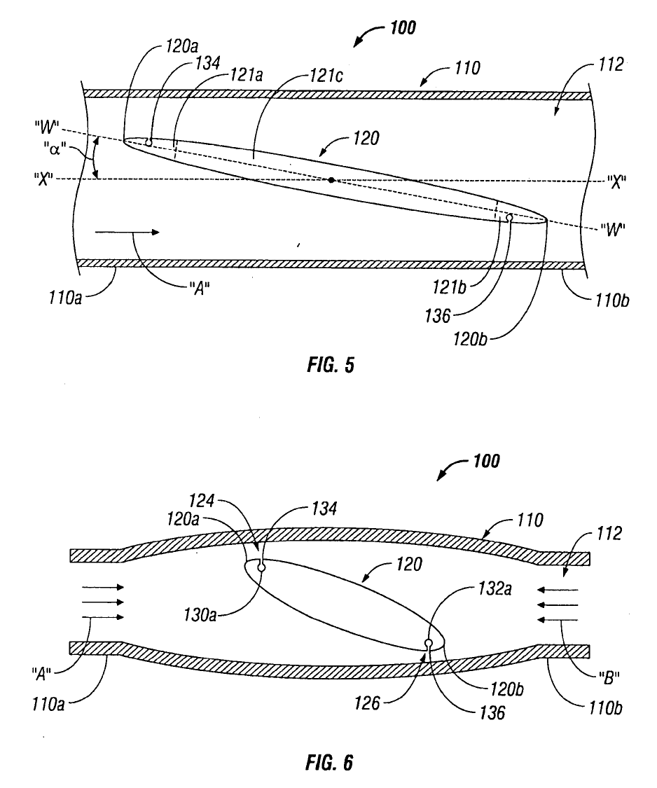

As seen in FIGS. 5 and 6, airfoil 120 is mounted in lumen 112 of tubular housing 110 such that the chord axis “W” thereof is disposed at an angle or angle of attack “α” relative to the longitudinal axis “X” of tubular housing 110. It is contemplated that the angle of attack “α” of airfoil 120 relative to tubular housing 110 is approximately between 8° and 10°, and particularly equal to about 9°. It is further contemplated that the angle of attack “α” of airfoil 120 may be approximately 0° or 0°.

As is known in the art, the angle of attack of an airfoil affects the pressure differentials which may be developed and measured. If the angle of attack is too high, the airflow over the airfoil may separate from the airfoil and result in a stall condition. If the angle of attack is too low, the airflow over the airfoil may result in a generation of an insufficient pressure differential.

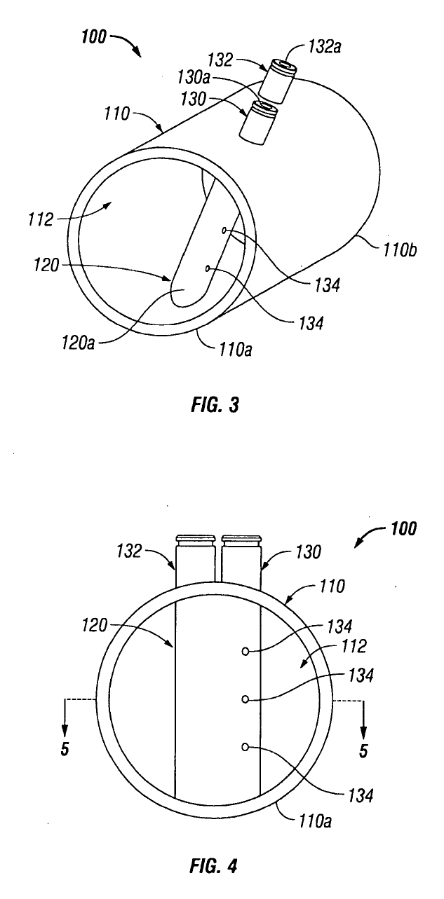

As seen in FIGS. 3 and 4, pneumotach 100 includes at least a pair of pressure ports 130, 132 extending from a side surface of airfoil 120 and through tubular housing 110. Each pressure port defines a respective lumen 130a, 132a extending into airfoil 120. Each lumen 130a, 132a of respective pressure ports 130, 132 is in fluid communication with at least one respective pressure tap or aperture 134, 136 formed in the surface of airfoil 120.

In one exemplary embodiment, as seen in FIGS. 3 and 4, airfoil 120 may be provided with three apertures 134 formed in the surface thereof and which are in fluid communication with lumen 130a of pressure port 130. Similarly, airfoil 120 may be provided with apertures 136 (not explicitly shown) formed in the surface thereof and which are in fluid communication with lumen 132a of pressure port 132.

Apertures 134, 136 of airfoil 120 are formed at either at or near the leading (proximal) edge of the airfoil above the cord axis (W), and at or near the trailing edge below the cord axis. As seen in FIG. 6, aperture(s) 134 is/are located at or near a superior leading edge 124 of airfoil 120, and aperture(s) 136 is/are located at or near an inferior trailing edge 126 of airfoil 120. In this configuration, aperture(s) 134 and 136 is/are located at a close radial distance to tubular housing 110 or at the narrowest location between airfoil 120 and tubular housing 110.

As seen in FIG. 5, airfoil 120 may include a first portion 121a, a second portion 121b and an intermediate portion 121c disposed between the first and second portions 121a, 121b. The first portion 121a and the second portion 121b may each be approximately ⅛* a total length of airfoil 120 as measured along the chord axis “W”. In the present embodiment, in accordance with the present disclosure, as seen in FIG. 5, aperture(s) 134 may be formed or located in first portion 121a of airfoil 120 and along an upper surface thereof in order to measure a low pressure along airfoil 120 when fluid flow is in the direction of arrow “A”. Also as seen in FIG. 5, aperture(s) 136 may be formed or located in second portion 121b of airfoil 120 and along a lower surface thereof in order to measure a high pressure along airfoil 120 when fluid flow is in the direction of arrow “A”.

In an alternate embodiment, the second portion 121b may be approximately ⅕* a total length of airfoil 120 as measured along the chord axis “W”. In the present embodiment, aperture(s) may be formed or located in second portion 121b of airfoil 120 and along a lower surface thereof in order to measure a high pressure along airfoil 120 when fluid flow is in the direction of arrow “A”.

While three apertures 134 are shown formed in and/or across airfoil 120 it is envisioned or contemplated that any number of apertures may be formed in and/or across airfoil 120 near its leading or trailing edges.

In one embodiment, tubular housing 110 may have an inner diameter of approximately 24 mm, and each aperture 134, 136 may have a diameter of approximately 20 0.5 mm. For pediatric use the housing conduit may have a smaller cross section.

Pneumotach 120 may be formed from an inexpensive, readily mass-producible material, such as an injection moldable plastic, so that pneumotach 120 may be marketed as a disposable unit.

In use, a pressure transducer 50, as described above, is fluidly coupled to pressure ports 130, 132. An airflow is then communicated though tubular housing 110 of pneumotach 100 in the form of respiration from an individual or patient “P”. The respiratory airflow, as shown in FIG. 6, includes a flow in a first direction (e.g., exhalation as indicated by arrows “A”) over airfoil 120 and a flow in a second direction (e.g., inhalation as indicated by arrows “B”) over airfoil 120.

As the airflow passes over airfoil 120, a pressure differential or pressure reading is measured by pressure transducer 50 at or along aperture(s) 134 as air flows over airfoil 120 during exhalation and at or along aperture(s) 136 as air flows over airfoil 120 during inhalation.

These pressure differentials or readings are then communicated to or transmitted to a processor of pressure monitor 20 (shown in FIG. 2) and known techniques and algorithms may be employed to calculate various flow, volume, respiratory mechanics, and other respiratory parameters, as well as measurements of blood flow and blood gases.

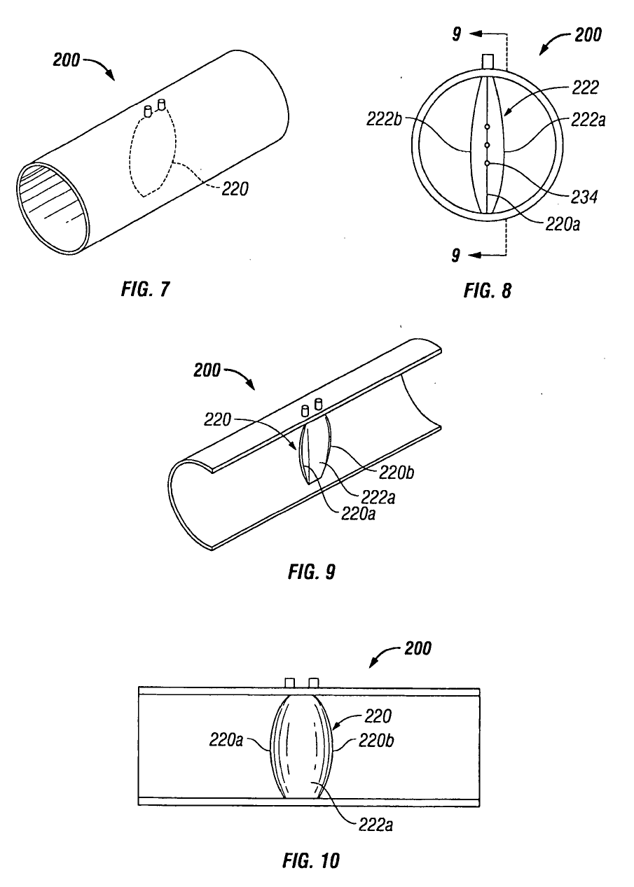

As seen in FIGS. 7-10, a pneumotach according to another embodiment of the present disclosure is generally shown as 200. Pneumotach 200 is substantially similar to pneumotach 100 and thus will only be discussed in detail herein to the extent necessary to identify differences in construction and/or operation.

As seen in FIGS. 7-10, airfoil 220 of pneumotach 200 may have a generally elliptical outer profile, wherein a leading and trailing edge 220a, 220b, respectively, thereof is arcuate, and wherein an upper and lower surface 222a, 222b, respectively, thereof has a generally convex profile.

Additionally, as seen in FIG. 8, airfoil 220 includes at least one aperture 234 formed in leading edge 220a thereof. It is contemplated that apertures (not shown) 20 may also be formed in trailing edge 220b thereof. As seen in FIG. 8, three apertures 234 may be formed in leading edge 220a of airfoil 220.

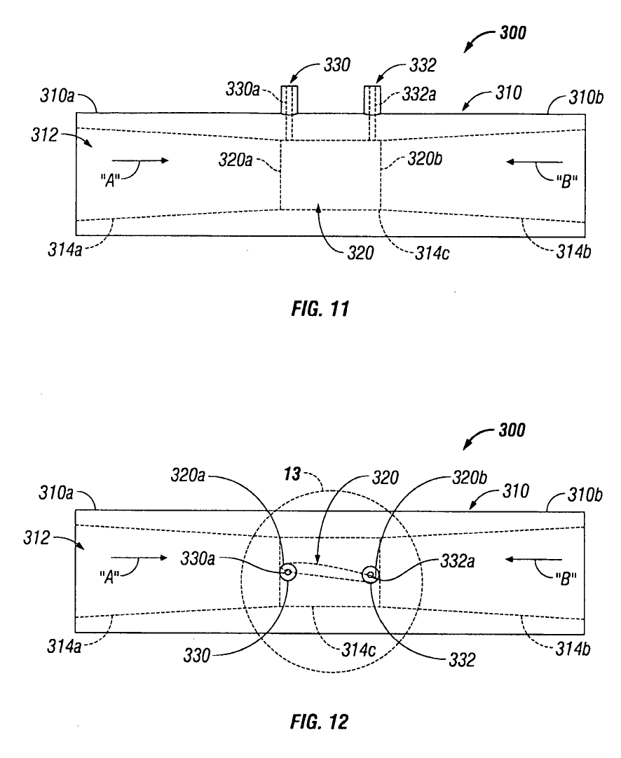

Turning now to FIGS. 11-14, a pneumotach according to a further embodiment of the present disclosure is generally shown as 300. Pneumotach 300 is substantially similar to pneumotach 100 and thus will only be discussed in detail herein to the extent necessary to identify differences in construction and/or operation. As seen in FIGS. 11-14, pneumotach 300 includes a tubular housing 310 defining a lumen 312 therethrough having a longitudinal axis “X”. Tubular housing 310 defines a first end 310a and a second end 310b.

Tubular housing 310 has a Venturi tube profile including a radially converging distal inner wall 314a, a radially diverging proximal inner wall 314b, and a constant diameter intermediate inner wall 314c interposed between distal inner wall 314a and proximal inner wall 314b.

As seen in FIGS. 11-14, pneumotach 300 further includes a vane, fin, airfoil or other aerodynamic member 320 supported in and extending diametrically across lumen 312 of tubular housing 310, in the region of intermediate wall 314c. Airfoil 320 may be disposed entirely within an axial length of intermediate wall 314c.

Airfoil 320 includes a leading edge 320a and trailing edge 320b defining a chord axis “W” therebetween. Airfoil 320 may be symmetrical along chord axis “W” and/or along a plane extending orthogonal to the chord axis “W”. Leading and trailing edges 320a, 320b may be radiused or rounded as needed or desired. In this manner, air flow over and around airfoil 320 in both a forward direction (arrows “A” of FIGS. 11-13) and reverse direction (arrows “B” of FIGS. 11-13) is substantially uniform or identical. Leading and trailing edges 320a, 320b may be substantially linear along their entire length.

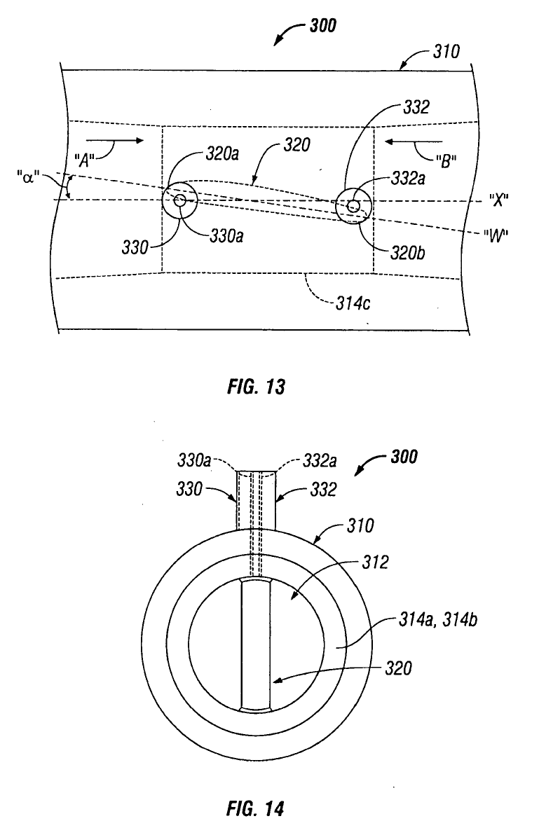

As seen in FIGS. 12 and 13, airfoil 320 is mounted in lumen 312 of tubular housing 310 such that the chord axis “W” thereof is disposed at an angle or angle of attack “α” relative to the longitudinal axis “X” of tubular housing 310. It is contemplated that the angle of attack “α” of airfoil 320 relative to tubular housing 310 is approximately between 0° and 45°; particularly between 8° and 10°, and more particularly between about 9° and 9.5°.

As is know in the art, the optimum angle of attack of an airfoil, for maximizing pressure differentials thereof, is dependent on the velocity of the flow of fluid (e.g., air) over the airfoil. Accordingly, the angles of attach selected herein, for airfoil 320 and any of the airfoils disclosed herein, is based on an fluid flow velocity of between approximately 1.0 Lpm to 60.0 Lpm (liters per minute). In accordance with the present disclosure, it is contemplated that the angle of attack “α” of airfoil 320 may be increased or decreased as needed or desired in order to maximize the pressure differentials thereof, depending on the value of the fluid flow velocity.

As is also known in the art, the angle of attack of an airfoil affects the pressure differentials which may be developed and measured. If the angle of attack is too high, the airflow over the airfoil may separate from the airfoil and result in a stall condition. If the angle of attack is too low, the airflow over the airfoil may result in a generation of an insufficient pressure differential.

As seen in FIGS. 11-14, pneumotach 300 includes a pair of pressure ports 330, 332 each defining a respective lumen 330a, 332a extending through tubular housing 5 310 and into lumen 312. In an alternate embodiment, pneumotach 300 includes at least a pair of pressure ports. Lumens 330a, 330b are formed near leading and/or trailing edge 320a, 320b of airfoil 320 depending on the direction of fluid flow through tubular housing 310. As seen in FIGS. 12 and 13, a first port 330 is positioned on tubular housing 310 at a location where lumen 330a thereof is located at the point of low pressure along airfoil 320 when fluid is flowing in the direction of arrow “A”. Also as seen in FIGS. 12 and 13, a second port 332 is positioned on tubular housing 310 at a location where lumen 332a thereof is located at the point of high pressure along airfoil 320 when fluid is flowing in the direction of arrow “B”. Lumens 330a, 332a may be located in a boundary layer around airfoil 320.

It is contemplated that the pneumotach 300 may further include additional ports (not shown) located at necessary or desired locations around airfoil 320. For example, ports may be place near a point low or lowest pressure along airfoil 320 when fluid is flowing in the direction of arrow “A” or “B”. Additionally, pressure ports may be placed at either or both edges of the airfoil where is meets the wall of the tube.

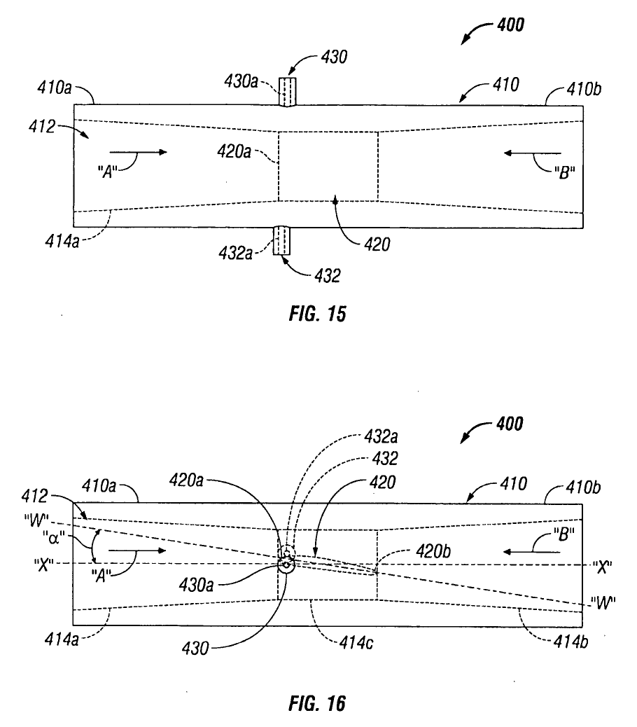

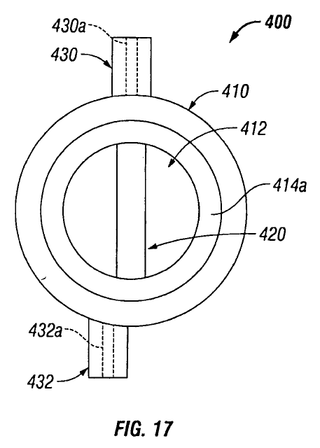

Referring now to FIGS. 15-17, a pneumotach according to a further embodiment of the present disclosure is generally shown as 400. Pneumotach 400 is substantially similar to pneumotach 300 and thus will only be discussed in detail herein to the extent necessary to identify differences in construction and/or operation.

As seen in FIGS. 15-17, pneumotach 400 includes a tubular housing 410 defining a lumen 412 therethrough having a longitudinal axis “X”. Tubular housing 410 defines a first end 410a and a second end 410b. Tubular housing 410 has a Venturi tube profile including a radially converging distal inner wall 414a, a radially diverging proximal inner wall 414b, and a constant diameter intermediate inner wall 414c interposed between distal inner wall 414a and proximal inner wall 414b.

As seen in FIGS. 15-17, pneumotach 400 further includes an airfoil 420 supported in and extending diametrically across lumen 412 of tubular housing 410, in the region of intermediate wall 414c.

Airfoil 420 is designed for unidirectional air flow and includes a leading edge 420a and trailing edge 420b defining a chord axis “W” therebetween. Unidirectional airflow pneumotachs may be useful to measure flow in devices. Airfoil 420 is substantially shaped as a wing or the like. In this manner, for optimal use, fluid may flow over and around airfoil 420 only in a forward direction (arrows “A” of FIGS. 15-16).

However, it is envisioned that while it is preferred that unidirectional fluid flow be communicated through pneumotach 400, pneumotach 400 may be used for bi-directional fluid flow as well. In this particular instance, optimum pressure readings may be obtained while fluid flow is in the direction of arrow “A”, and additional pressure readings may be taken for fluid flow in the direction of arrow “B” (i.e., opposite to the direction of arrow “A”). For pressure readings of fluid flow in the direction of arrow “B” an algorithm, computer software or other calibration methods known in the art may be used to evaluate and/or process the pressure readings obtained.

As seen in FIG. 16, airfoil 420 is mounted in lumen 412 of tubular housing 410 such that the chord axis “W” thereof is disposed at an angle or angle of attack “α” relative to the longitudinal axis “X” of tubular housing 410. It is contemplated that the angle of attack “α” of airfoil 420 relative to tubular housing 410 is approximately between 0° and 45°; particularly between 8° and 10°, and more particularly between about 9° and 9.5°.

As seen in FIGS. 15-17, pneumotach 400 includes at least a pair of pressure ports 430, 432 each defining a respective lumen 430a, 432a extending through tubular housing 410 and into lumen 412. Lumens 430a, 430b are formed near leading edge 420a of airfoil 420. As seen in FIG. 16, a first port 430 is positioned on a first side of tubular housing 410 at a location where lumen 430a thereof is located at the point of highest pressure along airfoil 420 when fluid is flowing in the direction of arrow “A”. Also as seen in FIG. 16, a second port 432 is positioned on a second side of tubular housing 410 at a location where lumen 432a thereof is located at the point of lowest pressure along airfoil 420 when fluid is flowing in the direction of arrow “A”. Lumens 430a, 432a may be located in a boundary layer around airfoil 420. It is contemplated that the pneumotach 400 may further include additional ports (not shown) located at necessary or desired locations around airfoil 420.

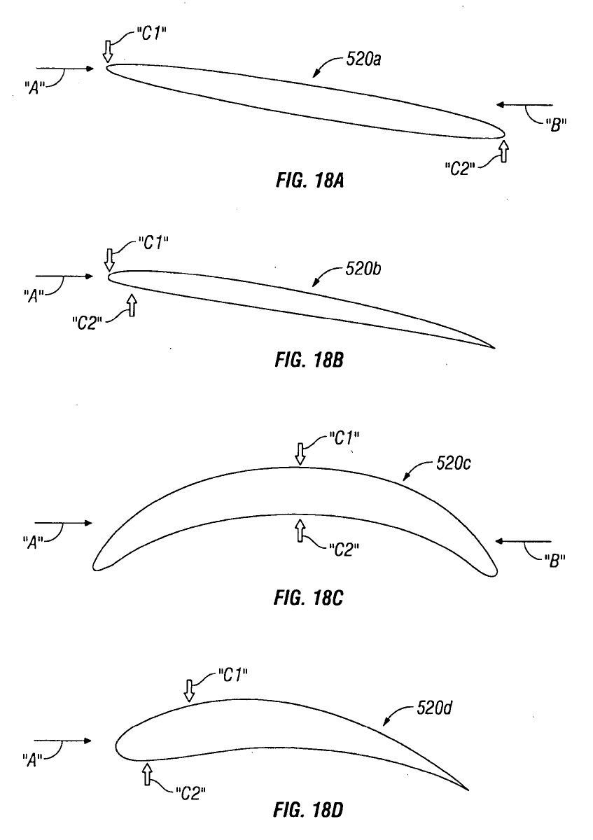

Turning now to FIGS. 18A-18D, various exemplary airfoils, for use in the pneumotachs disclosed herein, are shown and described. As seen in FIGS. 18A-18D, airflow is primarily in the direction of arrow “A”.

As seen in FIG. 18A, a symmetrical airfoil 520a, for measuring fluid flow in two directions (i.e., in the direction of arrows “A” and “B”), is shown. As seen in FIG. 10 18A, with fluid flow in the direction of arrow “A”, a first arrow “C1”, pointing down along a top surface of airfoil 520a, illustrates an approximate location for a tap at a location of low pressure, and a second arrow “C2”, pointing up along a bottom surface of airfoil 520a, illustrates the approximate location for atmospheric pressure or a tap at a location of high pressure. If fluid flow reverses, i.e., in the direction of arrow “B”, the 15 second arrow “C2” becomes the location of the low pressure tap, and the first arrow “C1” becomes the location of the high pressure tap. This allows both flow speed and direction to be determined.

As seen in FIG. 18B, an airfoil 520b configured for one direction or uni-directional flow, in the direction of arrow “A”, is shown. As seen in FIG. 18B, a first arrow “C1”, pointing down along an upper surface of airfoil 520b, illustrates the approximate location for a low pressure tap, while a second arrow “C2”, pointing upward along a bottom surface of airfoil 520b, illustrates the approximate location for a high pressure tap.

As seen in FIG. 18C, an airfoil 520c configured for one direction or uni-direction fluid flow, i.e., in the direction of arrows “A” and “B”, is shown. Airfoil 520c is a symmetrical ellipse type foil with camber. As seen in FIG. 18C, a first arrow “C1”, pointing down along an upper surface of airfoil 520c, illustrates the approximate location for a low pressure tap, while a second arrow “C2”, pointing upward along a bottom surface of airfoil 520c, illustrates the approximate location for a high pressure tap.

As seen in FIG. 18D, an airfoil 520d configured for one direction or uni-directional flow, in the direction of arrow “A”, is shown. As seen in FIG. 18D, a first arrow “C1”, pointing down along an upper surface of airfoil 520d, illustrates the approximate location for a low pressure tap, while a second arrow “C2”, pointing upward along a bottom surface of airfoil 520d, illustrates the approximate location for a high pressure tap.

As mentioned above, the location of arrows “C1” and “C2” illustrate the preferred approximate locations for taps or ports, however, it is understood that not all these locations are needed or may be used. The taps may be located on or long a surface of the airfoil, on the wall of the tubular housing, or any combination thereof. For example, at least one low pressure tap may be located on or along a surface of the airfoil, and at least one high pressure tap may be located on or along the wall of the surrounding tubular housing. Alternatively, in an embodiment, the high pressure tap may be eliminated and atmospheric pressure used in its place.

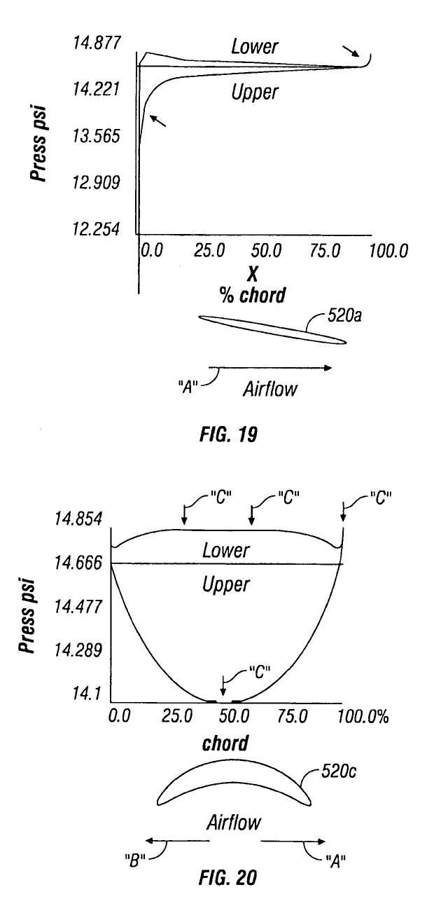

As seen in FIG. 19, a graphical illustration of pressure, versus chord location for airfoil 520a, as shown and described in FIG. 18A. As seen in FIG. 19, the 15 high pressure along an upper surface of airfoil 520a, a fluid flows in the direction of arrow “A”, is located in the proximity of the anterior of airfoil 520a. Also, as seen in FIG. 19, the low pressure point is located near the trailing edge of airfoil 520a. This allows airfoil 520a to have fluid flow in a forward and a reverse direction, thus giving data which provides both flow speed and direction. Arrows “C1” and “C2” of FIG. 19, illustrate approximate locations for the placement of pressure taps either on airfoil 520a or adjacent the tubular housing of the pneumotach.

As seen in FIG. 20, a graphical illustration of pressure versus chord location for airfoil 520c, as shown and described in FIG. 18C. As seen in FIG. 20, the high pressure areas are located along a lower surface of airfoil 520c. As seen in FIG. 20, several areas (as indicated by arrows “C”) where a pressure tap may be placed that would give a good high pressure reading on airfoil 520c with fluid flow in either a forward or reverse direction (as indicated by arrows “A” and “B”). For the upper surface (i.e., low pressure) the lowest pressure point and a good choice for a low pressure tap would be in the upper center of airfoil 520c (lower arrow “C”).

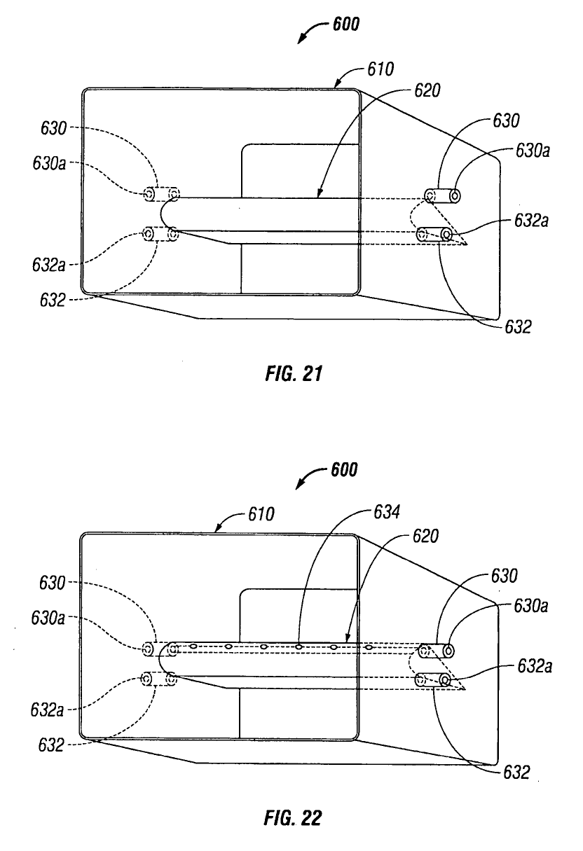

Turning now to FIG. 21, a pneumotach according to a further embodiment of the present disclosure is generally shown as 600. Pneumotach 600 includes a housing 610 defining a non-circular lumen 612. Housing 610 may have a rectangular outer profile or any other suitable outer profile known in the art. Pneumotach 600 further includes an airfoil 620 supported in and extending diametrically across lumen 612 of housing 610.

As seen in FIG. 21, pneumotach 600 includes at least a pair of pressure ports 630, 632 extending through a side wall of housing 610. Each pressure port 630, 632 defines a respective lumen 630a, 632a extending into housing 610.

As seen in FIG. 21, pressure ports 630 are formed near the leading (proximal) edge of the airfoil above a cord axis, and pressure ports 632 are formed near the leading edge below the cord axis.

In one exemplary embodiment, as seen in FIG. 22, pressure ports 630 may extend from a side surface of airfoil 620 and through housing 610. Airfoil 620 may be provided with a plurality of apertures 634 formed in the surface thereof and which are in fluid communication with lumen 630a of pressure port 630.

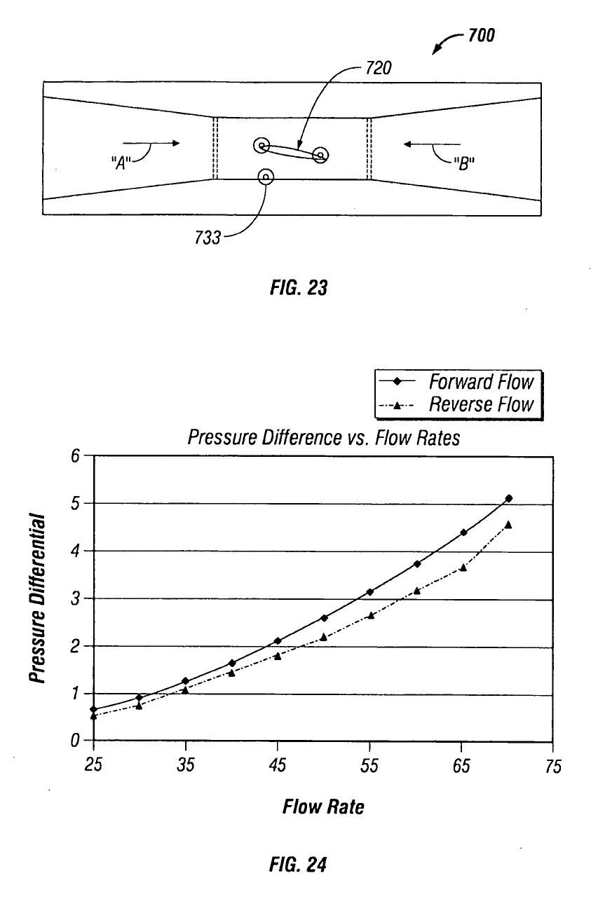

Turning now to FIG. 23, a pneumotach, including an asymmetrical airfoil 720, according to a further embodiment of the present disclosure, is generally shown as 700. Pneumotach 700 is substantially similar to pneumotach 400 and thus will only be discussed in detail herein to the extent necessary to identify differences in construction and/or operation.

Indirect calorimetry is a method of measuring metabolic activity in patients by determination of oxygen consumption and carbon dioxide production. This method is used for assessment of a patient's nutritional requirements and other testing. In this method ventilary flow is determined, and oxygen and carbon dioxide are measured in the exhaled breath and compared with the gas content of the inhaled air or other respiratory gas being delivered. This allows a precise measurement of oxygen use and carbon dioxide production by the test subject or patient. In this method precise measurement of exhaled gas is generally more important than the precision of measurement of inhaled gas.

By use of an asymmetrical airfoil 720, the precision of fluid flow can be optimized for one direction or unidirectional flow (i.e., in the direction of arrow “A”), while retaining the ability to measure flow, although with less precision, in the other or opposite direction (i.e., in the direction of arrow “B”). Knowing the flow characteristics of the pneumotach then allows use of calculations to determine the air or fluid flow in both directions.

For use in indirect calorimetry and cardiopulmonary exercise testing, pneumotach 700 may contain a sampling port 733 for sampling respiratory gases. This is especially important for testing when breath by breath analysis is performed. In a typical configuration, a pump (not shown) draws gases from pneumotach 700 during the test as a low rate, for example at about 150 ml per minute, and this gas is then tested for its CO2 and O2 content.

As seen in FIG. 24, a graphical illustration of the differences in flow rates for airfoil 720, in regards to fluid flow in the forward direction (the direction of arrow “A” of FIG. 23) and the reverse direction (the direction of arrow “B” of FIG. 23), is shown.

The present embodiments and examples are therefore to be considered in all respects as illustrative and not restrictive, the scope of the invention being indicated by the appended claims rather than the foregoing description, and all changes which come within the meaning and range of equivalency of the claims are therefore intended to be embraced therein.

We claim:

1. A pneumotach for measuring flow, the pneumotach comprising:
a housing defining a lumen and having a longitudinal axis; and,
an airfoil diametrically supported within the lumen of the housing and extending at least partially there across, the airfoil defining a chord axis, wherein the chord axis is one of angled with respect to the longitudinal axis and aligned with respect to the longitudinal axis.

2. The pneumotach according to claim 1, wherein the airfoil is symmetrical about the chord axis.

3. The pneumotach according to claim 1, wherein the airfoil includes at least one aperture formed therein within a leading one eighth of a length of the cord defined by the airfoil.

4. The pneumotach according to claim 3 wherein the airfoil includes at least one aperture formed therein within a trailing one eighth of a length of the cord defined by 15 the airfoil.

5. The pneumotach according to claim 1, wherein the chord axis of the airfoil is oriented at an angle of between about 8° and about 10° relative to the longitudinal axis.

6. The pneumotach according to claim 1, wherein the chord axis of the airfoil is oriented at an angle of about 9° relative to the longitudinal axis.

7. The pneumotach according to claim 1, wherein the lumen of the housing has a uniform inner diameter along its entire length.

8. The pneumotach according to claim 3, wherein the airfoil includes at least one pressure port formed therein and extending through the tubular housing and through a side surface thereof, wherein each aperture is in fluid communication with the at least one pressure port.

9. The pneumotach according to claim 4, wherein the airfoil includes at least one aperture formed within the leading one eighth of the cord above the cord axis, and wherein the airfoil includes at least one aperture formed within the trailing one fifth of the length of the cord.

10. The pneumotach according to claim 8, wherein the airfoil includes at least two apertures formed proximate a superior leading edge and at least two apertures formed proximate an inferior trailing edge.

11. The pneumotach according to claim 9, further comprising a pair of pressure ports extending into the airfoil through a side surface thereof, wherein a first pressure port is in fluid communication with the apertures formed at the apex of the airfoil and the second pressure port is in fluid communication with the apertures formed at the nadir of the airfoil.

12. The pneumotach according to claim 2, wherein the airfoil is symmetrical about a plane that is orthogonal to the chord axis.

13. The pneumotach according to claim 1, wherein an upper and a lower surface of the airfoil has a substantially convex profile.

14. The pneumotach according to claim 1, wherein a leading edge and a trailing edge of the airfoil has an arcuate profile extending from opposed ends thereof.

15. The pneumotach according to claim 1, wherein the tubular housing includes an inner wall having a Venturi profile.

16. The pneumotach according to claim 1, further comprising:
at least one pressure port extending into the lumen of the housing and formed proximate a superior leading edge of the airfoil;
at least one pressure port extending into the lumen of the housing and formed proximate a superior trailing edge of the pressure port; and
at least one sample port extending into the lumen of the housing and formed at any location along the housing.

17. The pneumotach according to claim 1, further comprising:
at least one sample port extending into the lumen of the housing.

18. A method of monitoring and/or measuring a fluid flow pressure, comprising the steps of:
providing a fluid pressure measuring system including a pneumotach, wherein the pneumotach includes:
a housing defining a lumen and having a longitudinal axis; and
an airfoil diametrically supported within the lumen of the tubular housing and extending at least partially thereacross, the airfoil defining a chord axis, wherein the chord axis is one of angled with respect to the longitudinal axis and aligned with respect to the longitudinal axis;
flowing a fluid through the housing of the pneumotach, in at least one of a forward and a reverse direction; and
measuring a pressure differential on a surface of the airfoil.

19. The method according to claim 18, wherein the fluid pressure measuring system is part of a respiratory measurement system.

20. A system for measuring a fluid flow, the system comprising:
a pneumotach including:
a housing defining a lumen and having a longitudinal axis; and
an airfoil diametrically supported within the lumen of the housing and extending at least partially thereacross, the airfoil defining a chord axis, wherein the chord axis is one of angled with respect to the longitudinal axis and aligned with respect to the longitudinal axis; and
a pressure transducer, in fluid communication with the lumen of the housing, for measuring a pressure differential in the housing of the pneumotach.

21. The respiratory system according to claim 20, wherein the airfoil is symmetrical about at least one of the chord axis and a plane that is orthogonal to the chord axis.

22. The respiratory system according to claim 20, wherein the chord axis of the airfoil is oriented at an angle of about 9° relative to the longitudinal axis.

23. The respiratory system according to claim 20, wherein the airfoil of the pneumotach defines an apex and a nadir, and wherein the airfoil includes at least one aperture formed therein at the apex and at least one aperture formed therein at the nadir.

24. The respiratory system according to claim 23, wherein the airfoil of the pneumotach includes three apertures formed at the apex and three apertures formed at the nadir.

25. The respiratory system according to claim 23, wherein the pneumotach further includes a pair of pressure ports extending into the airfoil through a side surface thereof, wherein a first pressure port is in fluid communication with the apertures formed at the apex of the airfoil and the second pressure port is in fluid communication with the apertures formed at the nadir of the airfoil.

26. The respiratory system according to claim 25, wherein the pressure transducer is fluidly associated with each pressure port.

27. A system for measuring a fluid flow, the system comprising:
a pneumotach including:
a housing defining a lumen and having a longitudinal axis; and
a uni-directional airfoil diametrically supported within the lumen of the housing and extending at least partially thereacross, the airfoil defining a chord axis, wherein the chord axis is one of angled with respect to the longitudinal axis and aligned with respect to the longitudinal axis; and
a pressure transducer, in fluid communication with the lumen of the housing, for measuring a pressure differential in, the housing of the pneumotach for bi-directional fluid flow across the airfoil.
